(19) United States
(12) Patent Application Publication
(10) Pub. No.: US 2025/0326408 A1
(43) Pub. Date: Oct. 23, 2025

(54) METHOD FOR CONTROLLING A DRIVING FUNCTION OF A MOVABLE DEVICE

(71) Applicant: Robert Bosch GmbH, Stuttgart (DE)

(72) Inventor: Carsten Hasberg, Ilsfeld-Auenstein (DE)

(21) Appl. No.: 19/176,602

(22) Filed: Apr. 11, 2025

(30) Foreign Application Priority Data
Apr. 17, 2024 (DE) 10 2024 203 533.5

(51) Int. Cl. B60W 60/00; G05D 1/69; G05D 101/10

(52) U.S. Cl. CPC B60W 60/0027; G05D 1/69; B60W 2554/4046; B60W 2556/40; G05D 2101/10

(57) ABSTRACT

A method for controlling a driving function of a movable device, including a vehicle or a robot. The method includes: reading in parameters for controlling the driving function; using a map, wherein the map has at least a first region and a second region, wherein at least one value of a swarm behavior is entered in the second region; locating the device in the map; using the parameters to ascertain the driving function, if the movable device is in the first region of the map; using the at least one value of the swarm behavior to ascertain the driving function, if the movable device is in the second region of the map; controlling the device with the ascertained driving function. A method for creating a map for ascertaining a driving function of a movable device, a computing unit, a computer program, and a machine-readable storage medium, are also described.

### CROSS REFERENCE

The present application claims the benefit under 35 U.S.C. § 119 of German Patent Application No. DE 10 2024 203 533.5 filed on Apr. 17, 2024, which is expressly incorporated herein by reference in its entirety.

### FIELD

The present invention relates to a method for controlling a driving function of a movable device. Furthermore, the present invention comprises a method for creating a map for controlling a driving function. The present invention further comprises a computing unit, a computer program product, and a machine-readable storage medium.

### BACKGROUND INFORMATION

Methods for controlling a driving function for a movable device are described in the related art.

### SUMMARY

It is an object of the present invention to provide an improved method for controlling a driving function of a movable device, in particular a vehicle or a robot. Furthermore, an object of the present invention is to provide an improved method for creating a digital map for ascertaining a driving function of a device.

These objects may be achieved by the methods according to certain features of the present invention. Advantageous embodiments of the present invention are disclosed herein.

According to a first aspect of the present invention, a method for controlling a driving function of a movable device, in particular a vehicle or a robot, is provided. According to an example embodiment of the present invention, the method comprises the following steps:
reading in parameters for controlling the driving function,
using a map, wherein the map has at least a first region and a second region, wherein at least one value of a swarm behavior is entered in the second region,
locating the movable device on the map,
using the parameters to ascertain the driving function, if the movable device is in the first region of the map,
using the at least one value of the swarm behavior to ascertain the driving function, if the movable device is in the second region of the map,
controlling the movable device with the ascertained driving function.

This makes it possible to achieve a technical advantage of providing an improved method for controlling a driving function of a movable device. This is achieved by using a map with at least a first region and a second region, at least one value of a swarm behavior being entered in the second region. The device is located in the map used. If the device is located within the first region of the map, the parameters are used to ascertain the driving function. If the device is located within the second region of the map, the at least one value of the swarm behavior is used to ascertain the driving function. Thus, in contrast to the control of a driving function which is implemented exclusively via a behavior map, the technical effort can be significantly reduced. This offers the advantage that the driving function needs to be controlled less frequently via the swarm behavior from a behavior map. The driving function represents a required driving behavior with the proposed method. Frequent application of the parameters for the driving function can advantageously be significantly reduced. This means that less data about swarm behavior need to be transmitted to the device or stored.

In an advantageous example embodiment of the present invention, the values of the swarm behavior of the second region comprise a plurality of values of the driving behavior of vehicles. The driving behavior values include, for example, vehicle velocities during driving maneuvers, vehicle stopping points, lane change points, overtaking zones, or trajectories. In particular, an average value of the values of the driving behavior of vehicles is used as values of the swarm behavior.

This offers the advantage that the swarm behavior in the second regions of the map is adapted as precisely as possible to the current environmental conditions. Thus, an increase in the accuracy of the method for controlling the driving function can be achieved.

In a further example embodiment of the present invention, the parameters for controlling the driving function come from calculations, the calculations being performed on the basis of the swarm behavior of the behavior map. For the calculations, target values are defined from the swarm behavior, the calculations being performed in iterative steps until the parameters provide a solution for reaching the target values, or until the parameters in a final iterative step provide the same number of achieved target values as in a previously performed penultimate iterative step.

This can, for example, achieve the technical advantage that the control uses the parameters to exactly reproduce a required swarm behavior in as many regions of the map as possible. This can reduce the use of a behavior map in the second regions of the map. This means that the processing effort for applying the parameters and the complex transmission of the behavior map to the vehicle can be further reduced.

In a further example embodiment of the present invention, the driving function controls the device, in particular the vehicle or the robot, in a partially or fully autonomous driving mode.

According to a second aspect of the present invention, a method for creating a map for ascertaining a driving function of a device is provided. According to an example embodiment of the present invention, the method comprises the steps of:
controlling the driving function of the device with the help of specified parameters, the driving function controlling the device in a partially or fully autonomous driving mode,
locating the device within a behavior map, the behavior map containing information about a swarm behavior of traveling devices, the swarm behavior having values with a specifiable tolerance zone,
ascertaining measured values of the driving function of the device,
comparing the measured values and the values of the swarm behavior of the behavior map,
creating a map with at least a first region and a second region, the first region of the map being defined as the region in which the comparison between the measured values and the values of the swarm behavior lies within the specifiable tolerance zone, the second region being defined as the region in which the comparison between the measured values and the values of the swarm behavior lies outside the specifiable tolerance zone, the values of the swarm behavior of the behavior map being entered for the second region.

This can, for example, achieve the technical advantage that a map for ascertaining a driving function contains as much and as precise information as possible about the control of a driving function with the help of specified parameters. By creating the first regions and the second regions, the map thus has information as to whether the driving function, with the help of the specified parameters, represents the swarm behavior within a specifiable tolerance zone or outside a specifiable tolerance zone. This therefore means that the map can contain precise information about the control of the driving function with the help of the specified parameters.

In an advantageous example embodiment of the present invention, the swarm behavior of the behavior map comes from swarm behavior data, the swarm behavior data comprising a wealth of information about the driving behavior of vehicles, the information including in particular velocities of vehicles during driving maneuvers, the swarm behavior of the behavior map describing an average value of the information from the swarm behavior.

This can, for example, achieve the technical advantage that the map created describes a swarm behavior of a plurality of vehicles particularly precisely.

In an advantageous embodiment of the present invention, the parameters for controlling the driving function come from calculations, the calculations being performed on the basis of the swarm behavior of the behavior map. For the calculations, target values are defined from the swarm behavior, the calculations being performed in iterative steps until the parameters provide a solution for reaching the target values, or until the parameters in a final iterative step provide the same number of achieved target values as in a previously performed penultimate iterative step.

This can, for example, achieve the technical advantage that the parameters are adapted as precisely as possible to the swarm behavior from the behavior map and as many defined target values as possible are thus achieved. This can result in improved performance of the driving function.

According to a third aspect of the present invention, a computing unit is proposed, which is configured to carry out the method according to the present invention.

According to a fourth aspect of the present invention, a computer program is provided, comprising the commands that, when the computer program is executed by a computer, cause the computer to carry out a method according to the present invention.

According to a fifth aspect, a machine-readable storage medium is provided, on which the computer program is stored.

The present invention is explained in more detail below with reference to exemplary figures and exemplary embodiments of the present invention.

### BRIEF DESCRIPTION OF THE DRAWINGS

FIG. 1 is a schematic flow chart of a method according to a first aspect of the present invention.

FIG. 2 is a schematic flow chart of a method according to a second aspect of the present invention.

FIG. 3 shows, by way of example, a movable device on a road section and a behavior map for creating a map, according to an example embodiment of the present invention.

FIG. 4 shows, by way of example, a map for ascertaining a driving function of a device, according to an example embodiment of the present invention.

FIG. 5 shows, by way of example, a movable device on a road section and a map, according to an example embodiment of the present invention.

FIG. 6 shows, by way of example, a movable device on a road section and a map, according to an example embodiment of the present invention.

FIG. 7 schematically shows a computing unit according to a third aspect of the present invention.

FIG. 8 shows a machine-readable storage medium according to a fifth aspect of the present invention.

### DETAILED DESCRIPTION OF EXAMPLE EMBODIMENTS

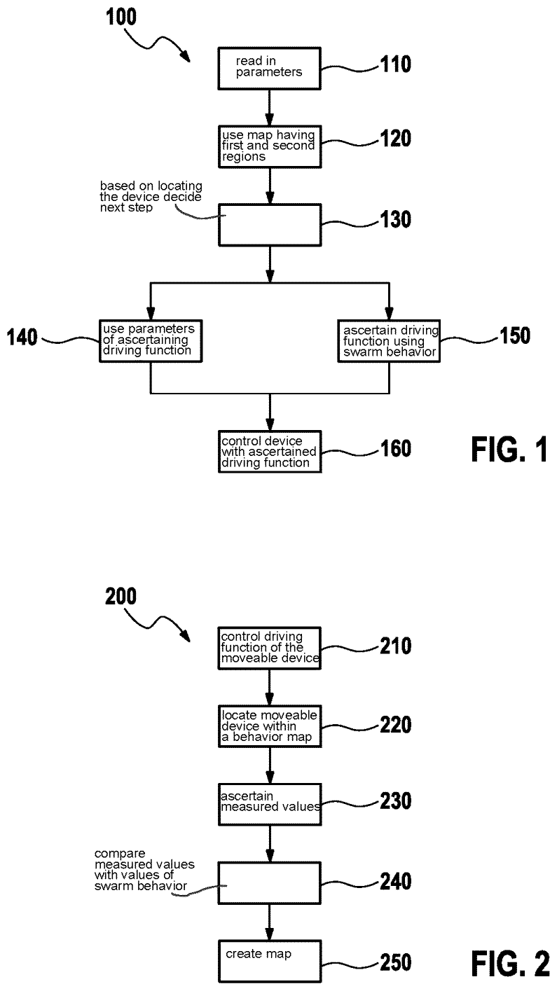

FIG. 1 shows a schematic flow chart of a method 100 according to a first aspect.

The method 100 serves to control a driving function of a movable device, in particular a vehicle or a robot. In this case, the method 100 comprises the following steps:

In a first step 110, parameters for controlling the driving function are read in.

The parameters for controlling the driving function can, for example, be used to control the device in an autonomous or semi-autonomous mode. The parameters give the driving function information about how the device should be controlled. For example, the parameters can contain information for the driving function, such as an acceleration duration, an acceleration level, or a braking distance or a braking duration. Furthermore, it is also conceivable that the driving function receives information about when the driving function should steer the device through a curve and when the driving function should drive straight ahead.

Advantageously, the parameters for controlling the driving function come from calculations. The calculations are advantageously performed on the basis of a swarm behavior of a behavior map. Target values for the calculations are defined from the swarm behavior of the behavior map. The calculations are then performed in iterative steps until the parameters provide a solution for the defined target values. Alternatively, the calculations are performed in iterative steps until the parameters in a final iterative step provide the same number of target values as in a previously performed penultimate iterative step. The parameters for controlling the driving function are therefore advantageously adapted as precisely as possible to the driving behavior of a behavior map.

In a second step 120, a map is used, the map having at least a first region and a second region, at least one value of a swarm behavior being entered in the second region.

Advantageously, the values of the swarm behavior of the second region comprise a plurality of values of the driving behavior of vehicles. The values can include, for example, velocities of vehicles during driving maneuvers. The values of the swarm behavior are particularly preferably an average value of the values of the driving behavior of vehicles. The data sets of the swarm behavior preferably come from vehicles that are controlled manually and not controlled by assistance systems or automatic driving functions. The swarm behavior particularly preferably describes situations in which the drivers of manually controlled vehicles can freely choose the velocity, for example said vehicles are not following behind a truck or a tractor. It is also expedient to use a plurality of data sets for the swarm behavior. That is to say that the data sets should be representative and a large number of different behaviors should be covered.

In a third step 130, the device is located within the map. Based on the locating of the device, a decision is made between a fourth step 140 and a fifth step 150.

The locating of the device within the map can be performed with the help of conventional satellite localization methods, such as GPS.

In a fourth step 140, the parameters for ascertaining the driving function are used when locating the device in the first region of the map.

In a fifth step 150, the at least one value of the swarm behavior is used to ascertain the driving function, when locating the vehicle or the robot in the second region of the map.

In a sixth step 160, the device is controlled with the ascertained driving function.

By using the method 100, the driving function can represent a required driving behavior for controlling the device. By using the first region and the second region of the map, the application of the parameters for the driving function can be reduced.

Advantageously, there is no need for a constant transmission from a behavior map to the back-end of the device. The behavior map or the swarm behavior is only used in the second regions of the map. In the first regions of the map, the driving function can be controlled with the help of the read-in parameters.

FIG. 2 is a schematic flow chart of a method 200 according to a second aspect.

The method 200 is used to create a map for ascertaining a driving function of a device. In this case, the method 200 comprises at least the following steps:

In a first step 210, the driving function of the device is controlled with the help of specified parameters, the driving function controlling the device in a partially or fully autonomous driving mode.

Preferably, the parameters for the driving function come from calculations. The calculations are performed on the basis of a swarm behavior of a behavior map. For the calculations, target values are defined from the swarm behavior and the calculations are performed in iterative steps until the parameters provide a solution for achieving the target values. Alternatively, the calculations are performed until the parameters in a final iterative step provide the same number of achieved target values as in a previously performed penultimate iterative step.

In a second step 220, the device is located within a behavior map, the behavior map comprising information about a swarm behavior of traveling devices, the swarm behavior having values with a specifiable tolerance zone.

The swarm behavior of the behavior map preferably comes from swarm behavior data. The swarm behavior data contain a wealth of information about the driving behavior of devices, in particular vehicles. For example, the swarm behavior data can contain the velocities of vehicles during driving maneuvers. Preferably, the swarm behavior is determined from a plurality of swarm behavior data and can be determined as the average value of different velocities of vehicles during the same driving maneuver. Specifiable tolerance zones are defined for the target values of the swarm behavior. The tolerance zone can, for example, be a deviation from an average velocity of the swarm behavior. For example, an average velocity of 100 km/h with a tolerance zone of ±1 km/h can be represented.

In a third step 230, measured values of the driving function of the device are ascertained.

The ascertained measured values of the driving function are, for example, velocities of the device that are achieved at defined locations or regions with the help of the parameter-controlled driving function. Thus, while the device is being controlled with the help of the driving function, the velocities actually achieved by the device in a partially or fully autonomous driving mode are recorded.

In a fourth step 240, the measured values and the values of the swarm behavior of the behavior map are compared.

Each value of the swarm behavior with the associated tolerance zone is compared with the corresponding measured value from the journey.

In a fifth step 250, a map is created with at least a first region and at least a second region. The first region of the map is defined as the region in which the comparison between the measured values and the values of the swarm behavior lies within the tolerance zone, the second region being defined as the region in which the comparison between the measured values and the values of the swarm behavior lies outside the tolerance zone, the values of the swarm behavior of the behavior map being entered for the second region.

Consequently, the proposed method provides a map containing accurate information about the control of a device with a driving function on the basis of specified parameters. The map contains information about the regions in which the control of the driving function is represented with the help of the specified parameters within a defined tolerance zone. In the second region, the map contains the information that the control of the driving function with the help of the parameters is outside the specifiable tolerance zone, i.e., represents the desired driving behavior only insufficiently. The map created in this way can then be used to ascertain a driving function of a device. Preferably, the created map is used for the method according to the first aspect.

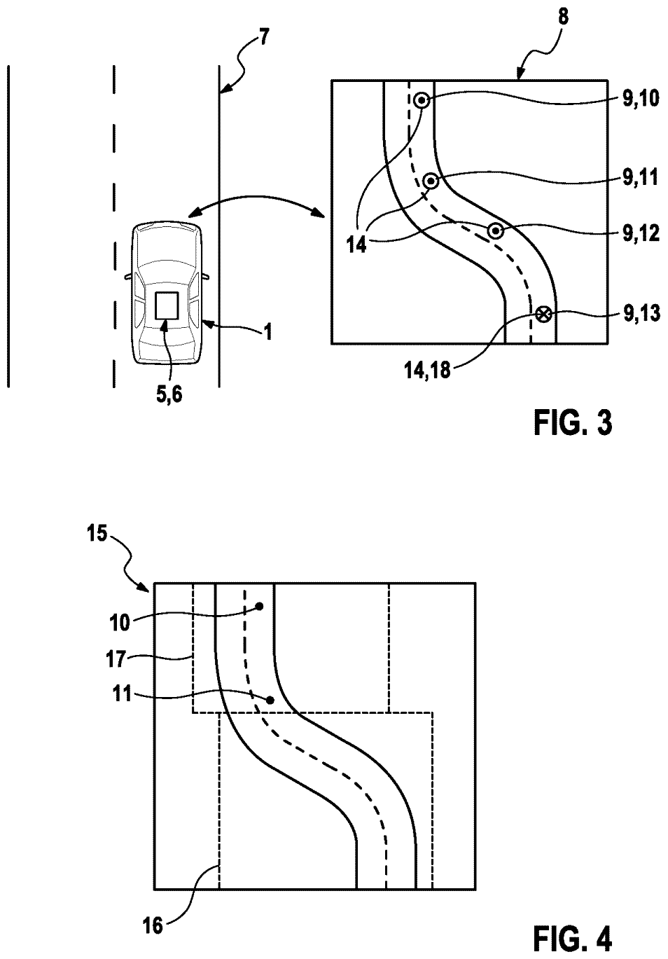

The following FIGS. 3 and 4 show, by way of example, how the method 200 can be used to create a map for ascertaining a driving function.

FIG. 3 shows, by way of example, a movable device 1 on a road section 7 and a behavior map 8 for creating a map. A movable device 1, in particular a vehicle, is on a road section 7. The movable device 1 can be any possible movable device, in particular also a robot. The movable device 1 is controlled with the help of a driving function 5 and specifiable parameters 6 into or in a partially or fully autonomous driving mode on the road section 7.

Furthermore, a behavior map 8 with information about swarm behavior 9 is shown. The behavior map 8 is a highly simplified representation and, by way of example, shows only a small part of a complete behavior map. The behavior map 8, for example, contains a road layout in the form of a curved road course. The road section 7 is part of the road course from the behavior map 8. The movable device 1 is located, for example, via a GPS signal within the behavior map 8 with the help of a localization point 18.

The behavior map 8 is stored, for example, on an external computing unit or a cloud. The parameters 6 for controlling the driving function 5 of the vehicle preferably come from calculations performed by an external computing unit on the basis of the behavior map 8. For the calculations, the swarm behavior 9 from the behavior map 8 is preferably used.

The swarm behavior 9 from the behavior map 8 comes from different test drives of vehicles and describes, for example, a plurality of velocities during different driving maneuvers.

Preferably, average velocities of manually controlled vehicles are used. Furthermore, the swarm behavior 9 can also include stopping points, lane change points, overtaking zones, and trajectories.

Target values 10, 11, 12, 13 are defined from the swarm behavior 9. Four target values 10, 11, 12, 13 are shown by way of example. On the basis of the target values 10, 11, 12, 13, calculations can be performed for the parameters 6. Preferably, the calculations are performed in iterative steps until the parameters 6 provide a solution for achieving the target values 10, 11, 12, 13, or until the parameters 6 in a final iterative step provide the same number of achieved target values 10, 11, 12, 13 as in a previously performed penultimate iterative step.

During the autonomous or semi-autonomous travel of the movable device 4, measured values 14 are recorded with the help of sensors. The measured values 14 include, for example, the velocities of the movable device 4 at the ascertained localization point 18 in the behavior map 8. Measured values 14 of the movable device are recorded for a plurality of target values 10, 11, 12, 13. A comparison of the target values 10, 11, 12, 13 and the measured values 14 is then performed. A tolerance zone is also specified for each target value. For example, a first target value 10 can have a tolerance zone of ±1 km/h. Furthermore, a second target value 11 can have a tolerance zone of ±2 km/h. The third target value 12 and the fourth target value 13 can, for example, again have a tolerance zone of ±1 km/h. From the comparison of the measured values 14 and the target values 10, 11, 12, 13, a statement can then be made as to whether the movable device 4 meets the defined requirements by using the driving function 5. A map is then created from the comparison of the measured values 14 and the target values 10, 11, 12, 13. A map created in this way is described by way of example in FIG. 4 below.

FIG. 4 shows, by way of example, a map 15 created for ascertaining a driving function of a movable device.

The map 15 has a first region 16 and a second region 17. The creation of these regions is based on the results of the comparison of the measured values and target values of FIG. 3. The first region 16 of the map is defined as the region in which the comparison between the measured values and the target values from the swarm behavior lies within the specified tolerance zone. Thus, in this example, the lower region of the map 15 was defined as the first region 16. In other words, this means that, in the first region 16, the driving function reproduces the required swarm behavior sufficiently well with the help of the parameters.

In the second region 17, the swarm behavior is entered into the map 15 in the form of the first target value 10 and the second target value 11. These values were entered since, for the target values 10, 11, the recorded measured values are outside the specified tolerance zone. In other words, this means that, in the second region 17, the target values 10, 11 could not be reproduced with sufficient accuracy by controlling the driving function and the parameters.

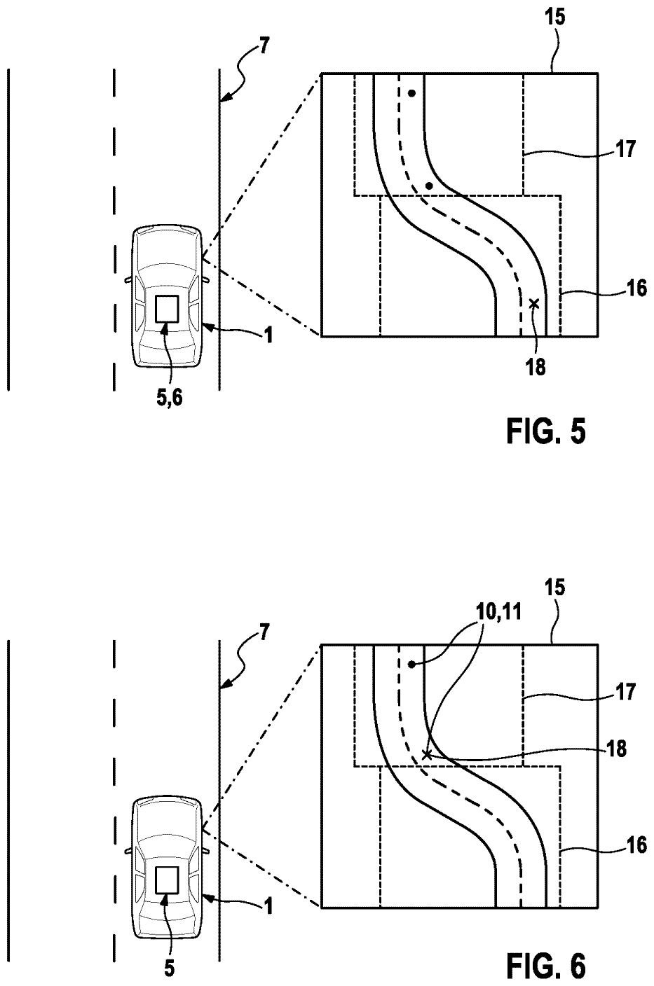

The map 15 thus created can be used to perform a method according to the first aspect. FIGS. 5 and 6 below serve as an exemplary description of the use of such a map 15.

FIG. 5 shows, by way of example, a movable device 1 on a road section 7 and a map 15.

The movable device 1 on the road section 7 is, by way of example, a vehicle. The vehicle has the map 15, a driving function 5, and parameters 6 for controlling the driving function 5. The map 15 was created using a method described above and illustrated in FIGS. 3 and 4. The map 15 is stored online in the movable device 1. While traveling on the road section 7, the movable device 1 is located in the map 15 via a localization point 18, for example via a GPS signal. The map 15 has a first region 16 and a second region 17.

In this example, the movable device 1 is located in the first region 16 with the help of the localization point 18. The movable device 1 therefore receives from the map 15 the information to use the parameters 6 for ascertaining the driving function 5 and to control it via the ascertained driving function 5.

FIG. 6 shows, by way of example, a movable device 1 on a road section 7 and a map 15.

The movable device 1 or the vehicle is again on a road section 7 and has the driving function 5. Furthermore, the map 15 with the first region 16 and the second region 17 is again stored in the movable device 1. The movable device 1 is located on the road section 7 via the localization point 18. In this exemplary embodiment, the movable device 1 is located in the second region 17 of the map. Since the locating, unlike in FIG. 5, is now in the second region 17 of the map, the parameters for ascertaining the driving function 5 are not used. In this case, the driving function 5 accesses the first target value 10 and the second target value 11, which are stored in the second region 17 of the map. In this exemplary embodiment, the driving function 5 is thus ascertained and controlled via the values of the swarm behavior, in particular the target values 10 and 11. The movable device 1 thus also reproduces the required swarm behavior here, when passing through the road section 7.

With reference to FIG. 5 and FIG. 6, it was thus shown how the driving function 5 can be ascertained for a movable device 1, for example when driving through a curve, with the help of the map 15. Depending on the region in which the movable device 1 or the localization point 18 for the device is, the correct driving function 5 is thus ascertained. This can significantly reduce frequent access to a behavior map or frequent adjustment of the parameters 6 for controlling the driving function 5. This offers the advantage that a movable device 1 can be controlled efficiently and with the desired performance in all regions of a map 15 by using the map 15.

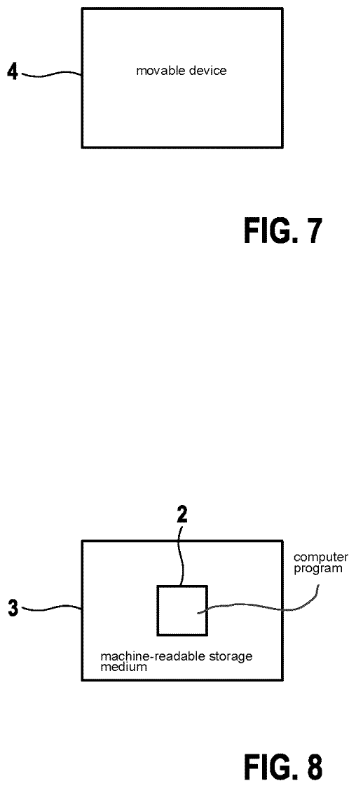

FIG. 7 shows a computing unit 4 according to a third aspect.

The computing unit 4 is configured to carry out all steps of the above-described methods, also in advantageous embodiments. The computing unit 4 can in particular be a computer.

FIG. 8 shows a machine-readable storage medium 3 according to a fifth aspect.

A computer program 2 according to the fourth aspect is stored on the machine-readable storage medium 3. The computer program 2 comprises commands that, when the computer program 2 is executed by a computer, cause the computer to carry out a method according to the independent claims. The machine-readable storage medium 3 can be read, for example, by the computing unit 4 of FIG. 7.

Although the present invention has been described herein with reference to specific exemplary embodiments, a person skilled in the art can also implement embodiments not disclosed or only partially disclosed, without departing from the essence of the present invention, in view of the disclosure herein.

What is claimed is:

1. A method for controlling a driving function of a movable device, comprising the following steps:
reading in parameters for controlling the driving function;
using a map, wherein the map has at least a first region and a second region, wherein at least one value of a swarm behavior is entered in the second region;
locating the device in the map;
using the parameters to ascertain the driving function, when the movable device is in the first region of the map;
using the at least one value of the swarm behavior to ascertain the driving function, when the movable device is in the second region of the map;
controlling the device with the ascertained driving function.

2. The method according to claim 1, wherein the movable device is a vehicle or a robot.

3. The method according to claim 1, wherein the value of the swarm behavior of the second region includes a plurality of values of the driving behavior of vehicles, wherein the values of the driving behavior of the vehicle include velocities of the vehicles during driving maneuvers, wherein the values of the swarm behavior describe an average value of the values of the driving behavior of vehicles.

4. The method according to claim 1, wherein the parameters (6) for controlling the driving function come from calculations, wherein the calculations are performed based on the swarm behavior of a behavior map, wherein target values for the calculations are defined from the swarm behavior, wherein the calculations are performed in iterative steps until the parameters provide a solution for achieving the target values, or until the parameters in a final iterative step provide the same number of achieved target values in a previously performed penultimate iterative step.

5. The method according to claim 1, wherein the driving function controls the movable device in a partially or fully autonomous driving mode.

6. A method for creating a map for ascertaining a driving function of a movable device, the method comprising the following steps:
controlling the driving function of the movable device using specified parameters, wherein the driving function controls the movable device in a partially or fully autonomous driving mode;
locating the movable device within a behavior map, wherein the behavior map has information about a swarm behavior of traveling devices, wherein the swarm behavior has values with a specifiable tolerance zone;
ascertaining measured values of the driving function of the movable device;
comparing the measured values and the values of the swarm behavior from the behavior map;
creating a map having at least a first region and a second region, wherein the first region of the map is defined as a region in which the comparison between the measured values and the values of the swarm behavior lies within the tolerance zone, wherein the second region is defined as a region in which the comparison between the measured values and the values of the swarm behavior lies outside the tolerance zone, wherein at least one value of the swarm behavior from the behavior map is entered for the second region.

7. The method according to claim 6, wherein the swarm behavior of the behavior map comes from swarm behavior data, wherein the swarm behavior data includes a wealth of information about the driving behavior of vehicles, wherein the information includes velocities of vehicles during driving maneuvers, wherein the swarm behavior of the behavior map describes an average value of the information from the swarm behavior data.

8. The method according to claim 6, wherein the parameters for controlling the driving function come from calculations, wherein the calculations are performed based on the swarm behavior of the behavior map, wherein target values for the calculations are defined from the swarm behavior, wherein the calculations are performed in iterative steps until the parameters provide a solution for achieving the target values, or until the parameters in a final iterative step provide the same number of achieved target values as in a previously performed penultimate iterative step.

9. A computing unit configured to control a driving function of a movable device, the computing unit configured to:
read in parameters for controlling the driving function;
use a map, wherein the map has at least a first region and a second region, wherein at least one value of a swarm behavior is entered in the second region;
locate the device in the map;
use the parameters to ascertain the driving function, when the movable device is in the first region of the map;
use the at least one value of the swarm behavior to ascertain the driving function, when the movable device is in the second region of the map;
control the device with the ascertained driving function.

10. A non-transitory machine-readable storage medium on which is stored a computer program for controlling a driving function of a movable device, the computer program, when executed by a computer, causing the computer to perform the following steps:
reading in parameters for controlling the driving function;
using a map, wherein the map has at least a first region and a second region, wherein at least one value of a swarm behavior is entered in the second region;
locating the device in the map;
using the parameters to ascertain the driving function, when the movable device is in the first region of the map;
using the at least one value of the swarm behavior to ascertain the driving function, when the movable device is in the second region of the map;
controlling the device with the ascertained driving function.
